(19) United States
(12) Patent Application Publication
(10) Pub. No.: US 2020/0131372 A1
(43) Pub. Date: Apr. 30, 2020

(54) AQUEOUS PIGMENT DISPERSIONS

(71) Applicant: Hewlett-Packard Development Company, L.P., Spring, TX (US)

(72) Inventors: Dennis Z. Guo, San Diego, CA (US); Jie ZHANG, San Diego, CA (US); Tienteh CHEN, San Diego, CA (US); Marcos A, BARRETO CABAN, Aguadilla, PR (US); June YANG, Aguadilla, PR (US); Rodney David STRAMEL, San Diego, CA (US)

(73) Assignee: Hewlett-Packard Development Company, L.P., Spring, TX (US)

(21) Appl. No.: 16/603,628

(22) PCT Filed: Sep. 14, 2017
(86) PCT No.: PCT/US2017/051461

§ 371 Date: Oct. 8, 2019

(51) Int. Cl. C09B 67/20; C09D 11/322; C09B 48/00; C09B 67/22; C08L 25/14; C08L 75/04; C08G 18/10; C08G 18/75; C08G 18/34; C08K 5/42; C08F 212/08; C08F 220/06; C08F 220/18; C08F 220/56

(52) U.S. Cl. CPC C09B 67/0066; C08K 2201/005; C09B 48/00; C09B 67/0036; C08L 25/14; C08L 75/04; C08G 18/10; C08G 18/755; C08G 18/348; C08K 5/42; C08F 212/08; C08F 220/06; C08F 220/18; C08F 220/56; C08F 2220/1825; C08L 2205/03; C08L 2201/54; C09D 11/322

(57) ABSTRACT

The present disclosure is drawn to aqueous pigment dispersions. In one example, an aqueous pigment dispersion can include from 40 wt % to 90 wt % water, from 2 wt % to 30 wt % organic co-solvent, from 7.5 wt % to 30 wt % quinacridone pigment, from 0.5 wt % to 3.5 wt % styrene-acrylic dispersant, and from 0.5 wt % to 3.5 wt % hydrophilic polyurethane dispersant having an acid number from 20 to 100. The styrene-acrylic dispersant and the hydrophilic polyurethane dispersant can be present at a weight ratio from 1:5 to 5:1.

### BACKGROUND

Inkjet printing has become a popular way of recording images on various media. Some of the reasons include low printer noise, variable content recording, capability of high speed recording, and multi-color recording. These advantages can be obtained at a relatively low price to consumers. As the popularity of inkjet printing increases, the types of use also increase providing demand for new ink compositions.

Pigmented inks have become particularly popular in recent years due to several advantages over dye-based inks. However, printing pigments can sometimes be a challenge as each pigment has different chemistry and thus, behaves differently when printing using inkjet printing technology. For example, some pigments present challenges with respect to stability, decap performance, decel performance, image quality, or the like. Thus, the formulation of pigment dispersions and/or ink compositions that address some of these and/or other issues can be desirable.

### BRIEF DESCRIPTION OF DRAWINGS

Additional features and advantages of the disclosure will be apparent from the detailed description which follows, taken in conjunction with the accompanying drawings, together illustrating, by way of example, features of the present technology. It should be understood that the figures are representative of examples of the present disclosure and should not be considered as limiting the scope of the disclosure.

FIG. 1 schematically represents an example pigment co-dispersed by two dispersants that are associated with the pigment in accordance with the present disclosure; and

FIG. 2 depicts an example method of formulating a latex ink composition in accordance with the present disclosure.

### DETAILED DESCRIPTION

Performance related printing challenges can exist with quinacridone ink compositions, and thus, the preparation of pigment dispersions and latex ink compositions that include quinacridone pigments that address some of these challenges can be desirable. For example, the structure of quinacridone crystals which include both hydrophobic and hydrophilic portions can make quinacridone pigments challenging to disperse adequately for inkjet applications. Additionally, formulating latex ink compositions with quinacridone pigments poses an additional challenge due to generally high concentrations of solids and other ingredients contained therein. Consequently, it can be difficult to formulate latex ink compositions, as well as pigment dispersions suitable for preparing latex ink compositions, with quinacridone pigments that can exhibit good stability, decap performance, and no drop velocity deceleration (“no decel”).

In accordance with this, the present disclosure relates generally to aqueous pigment dispersions, latex ink compositions, and methods of preparing latex ink compositions. In one example, an aqueous pigment dispersion can include from 40 wt % to 90 wt % water, from 2 wt % to 30 wt % organic co-solvent, from 7.5 wt % to 30 wt % quinacridone pigment, from 0.5 wt % to 3.5 wt % styrene-acrylic dispersant, and from 0.5 wt % to 3.5 wt % hydrophilic polyurethane dispersant having an acid number from 20 to 100. In one example, the styrene-acrylic dispersant and the hydrophilic polyurethane dispersant can be present at a weight ratio from 1:5 to 5:1. In one specific example, the weight ratio of the quinacridone pigment to total dispersant content (e.g., both dispersants) can be from 15:1 to 2:1. In another embodiment, the styrene-acrylic dispersant can have a weight average molecular weight from 4,000 Mw to 30,000 Mw and an acid number ranging from 100 to 350. Furthermore, the hydrophilic polyurethane can have a weight average molecular weight from 3,000 Mw to 20,000 Mw.

In another example, a latex ink composition can include an aqueous liquid vehicle, from 1 wt % to 7 wt % quinacridone pigment co-dispersed by a styrene-acrylic dispersant and a hydrophilic polyurethane dispersant, and from 1 wt % to 15 wt % latex particles. The quinacridone pigment can include a co-crystal of two quinacridone pigments. In another example, the weight ratio of quinacridone pigment to total dispersant content (e.g., both dispersants) can be from 15:1 to 2:1. A weight ratio of the styrene-acrylic dispersant to hydrophilic polyurethane dispersant can be from 1:5 to 5:1. In some examples, the styrene-acrylic dispersant can have a weight average molecular weight ranging from 4,000 Mw to 30,000 Mw and an acid number ranging from 100 to 350. Furthermore, the hydrophilic polyurethane can have a weight average molecular weight from 3,000 Mw to 20,000 Mw and an acid number from 20 to 100. In a further example, the hydrophilic polyurethane dispersant can have an average particle size ranging from 0.1 nm to 30 nm. The hydrophilic polyurethane can be a copolymerization product of from 25 wt % to 70 wt % of a non-aromatic polyisocyanate, from 5 wt % to 25 wt % of an acid monomer including one or both of a hydroxyl functional group or an amino functional group, and from 1 wt % to 60 wt % of a polyol, for example. In this example, the acid monomer can be dimethylolpropionic acid, and/or the non-aromatic polyisocyanate can be isophorone diisocyanate. In some examples, the latex particles can include a polymerized copolymer of a reactive surfactant and a monomer, wherein the reactive surfactant can be a polyoxyethylene alkylphenyl ether ammonium sulfate surfactant, an alkylphenol ethoxylate free polymerizable anionic surfactant, a sodium polyoxyethylene alkylether sulfuric ester based polymerizable surfactant, or a combination thereof. In this example, the monomer can be styrene, alkyl methacrylate, alkyl methacrylamide, butyl acrylate, methyacrylic acid, or a combination thereof.

In another example, a method of formulating a latex ink composition can include admixing an aqueous latex dispersion and an aqueous pigment dispersion including a quinacridone pigment co-dispersed by a styrene-acrylic dispersant and a hydrophilic polyurethane dispersant in a liquid vehicle to form the latex ink composition. The latex ink composition can include from 1 wt % to 7 wt % of the quinacridone pigment and from 1 wt % to 15 wt % latex particles. The styrene-acrylic dispersant can have a weight average molecular weight from 4,000 Mw to 30,000 Mw and an acid number from 100 to 350, and the hydrophilic polyurethane can have a weight average molecular weight from 3,000 Mw to 20,000 Mw and an acid number from 20 to 100, for example.

It is noted that when discussing the aqueous pigment dispersion, latex ink composition, and the method of formulating a latex ink composition, each of these discussions can be considered applicable to other examples whether or not they are explicitly discussed in the context of that example unless expressly indicated otherwise. Thus, for example, in discussing a styrene-acrylic dispersant related to a latex ink composition, such disclosure is also relevant to and directly supported in context of the aqueous pigment dispersion, the method of formulating the latex ink composition, and vice versa.

The aqueous pigment dispersions, latex ink compositions, and method of preparing latex ink compositions presented herein can incorporate quinacridone pigments. Derivatives of quinacridone can be utilized to create quinacridone pigments. Quinacridone is an organic molecule including the general formula C₂₀H₁₂N₂O₂ or the structure shown in Formula I below.

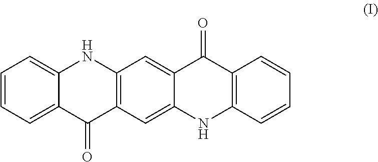

Quinacridone pigments can include a hydrophobic portion and a hydrophilic portion which can render them difficult to maintain good stability after storage for an extended period of time. Despite dispersion challenges, quinacridone pigments can be high performance pigments with exceptional color, light fastness, and weather fastness, making them desirable for use ink compositions.

Quinacridone pigments utilized herein are not particularly limited. Exemplary quinacridone pigments that can be utilized can include PR122, PR192, PR202, PR206, PR207, PR209, P048, P049, PV19, PV42, and the like. These pigments tend to be magenta, red, orange, violet, or other similar colors. In one example, the quinacridone pigment can be PR122, PR202, PV19, or a combination thereof. In another example, the quinacridone can be a co-crystal of two quinacridone pigments.

The quinacridone pigment can be present at varying concentrations in the aqueous pigment dispersion and/or the latex ink composition. For example, the quinacridone pigment can be present in an aqueous pigment dispersion (used to formulate the ink compositions) at from 7.5 wt % to 30 wt %. In yet other examples, the quinacridone pigment can be present in the aqueous pigment dispersion at from 10 wt % to 20 wt %, or from 12 wt % to 18 wt %. These weight percentages are intended to be independent of the two dispersants that are included in the aqueous pigment dispersion as a whole. On the other hand, the quinacridone pigment (dispersed by the two dispersants) can be present at from 1 wt % to 7 wt %, from 2 wt % to 6 wt %, from 1 wt % to 5 wt %, from 2 wt % to 5 wt %, or from 2 wt % to 4 wt % in the latex ink composition. Thus, when formulating the latex ink composition, the pigment in the pigment dispersion can become diluted with additional ingredients, such as additional water or other liquid vehicle compositions, latex, etc.

The weight ratio of quinacridone pigment to total dispersant content (e.g., both types of dispersant included) in the aqueous pigment dispersion or the latex ink composition can vary. For example the weight ratio can be from 15:1 to 2:1, from 10:1 to 2:1, from 5:1 to 3:1, etc. Thus, the quinacridone pigment can be co-dispersed by a styrene-acrylic dispersant and a hydrophilic dispersant within these weight ratios, as an example.

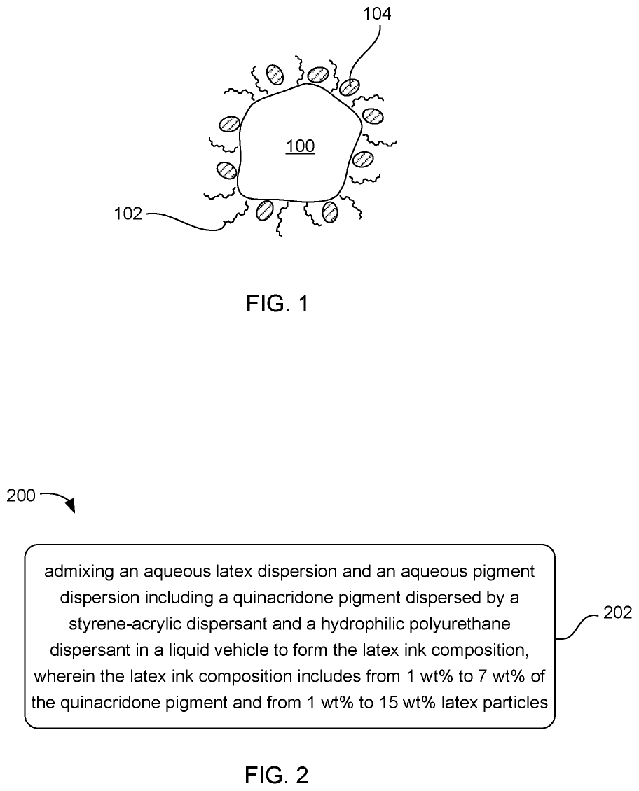

By way of example, FIG. 1 schematically depicts a quinacridone pigment 100 that is co-dispersed by two dispersants, namely a styrene-acrylic dispersant 102 and a hydrophilic polyurethane 104 as shown in FIG. 1. In one example, the weight ratio of styrene-acrylic dispersant to hydrophilic polyurethane dispersant can be from1:5 to 5:1, 1:3 to 3:1, from 1:2 to 2:1, or from 1:1. In some examples, the weight ratio can be about 2:1, about 1:1, or about 1:2.

Notably, the structure of the pigments and the dispersants is not intended to be to scale or to represent chemical structure, but rather to simply show that there are two different types of dispersants associated with a surface of the quinacridone pigment. Additionally, in accordance with the present disclosure, the dispersants are not covalently attached to the pigment surface, but rather electrostatically or otherwise associated with the pigment surface. The styrene-acrylic resin can associate with the pigment through π-stacking between the aromatic rings from quinacridone pigment and from styrene, absorption or other similar attractions. The hydrophilic polyurethane dispersant can associate with the pigment through adsorption, hydrogen bonding, or other similar attractions. For example, the hydrogen bonding can occur between a urethane of the polyurethane and electronegative atoms at a surface of the quinacridone pigments.

In one example, the styrene-acrylic dispersant can have a weight average molecular weight from 4,000 Mw to 30,000 Mw. In another example, the styrene-acrylic dispersant can have a weight average molecular weight of 8,000 Mw to 28,000 Mw, from 12,000 Mw to 25,000 Mw, from 15,000 Mw to 25,000 Mw, from 15,000 Mw to 20,000 Mw, or about 17,000 Mw. Regarding the acid number, the styrene-acrylic dispersant can have an acid number from 100 to 350, from 120 to 350, from 150 to 300, from 180 to 250, or about 214, for example. Exemplary commercially available styrene-acrylic dispersants can include Joncryl® 671, Joncryl® 71, Joncryl® 96, Joncryl® 680, Joncryl® 683, Joncryl® 678, Joncryl® 690, Joncryl® 296, Joncryl® 671, or Joncryl® 696 (all available from BASF Corp., Germany).

The hydrophilic polyurethane can also be included to provide additional dispersion properties to the quinacridone pigment. In one example, the hydrophilic polyurethane can have a weight average molecular weight ranging from 3,000 Mw to 20,000 Mw, from 5,000 Mw to 15,000 Mw, or from 10,000 Mw to 12,000 Mw. In one example, the hydrophilic polyurethane dispersant can have a weight average molecular weight of about 10,000 Mw to 12,000 Mw. In some examples, the hydrophilic polyurethane can have an acid number ranging from 20 to 100, from 30 to 85, from 40 to 75, or from 50 to 60. The particle size of the hydrophilic polyurethane dispersant can range from 0.1 nm to 30 nm, from 1 nm to 25 nm, from 10 nm to 30 nm, or from 2 nm to 8 nm.

In one example, the hydrophilic polyurethane dispersant can be a copolymerization product of a non-aromatic polyisocyanate, an acid monomer, and a polyol, for example. In further detail, the hydrophilic polyurethane dispersant can be a copolymerization product of from 25 wt % to 70 wt % the non-aromatic polyisocyanate, from 5 wt % to 25 wt % of the acid monomer including one or both of a hydroxyl functional group or an amino functional group, and from 1 wt % to 60 wt % of the polyol.

Exemplary non-aromatic polyisocyanates that can be used include hexamethylene-1,6-diisocyanate; 1,12-dodecane diisocyanate; 2,2,4-trimethyl-hexamethylene diisocyanate; 2,4,4-trimethyl-hexamethylene diisocyanate; 2-methyl-1,5-pentamethylene diisocyanate; isophorone diisocyanate; 4,4′-diisocyanato dicyclohexylmethane; or combinations thereof. In one example, the non-aromatic polyisocyanate can be isophorone diisocyanate. In some examples, the non-aromatic polyisocyanate can be present in the copolymerization reaction from 30 wt % to 70 wt %, from 35 wt % to 66 wt %, or from 40 wt % to 55 wt %. In one example, the non-aromatic polyisocyanate can be an aliphatic or cycloaliphatic polyisocyanate.

Exemplary acid monomers that can be used in the copolymerization reaction can include dimethylolpropionic acid, dimethylol butanoic acid, citric acid, tartaric acid, glycolic acid, lactic acid, malic add, dihydroxymaleic acid, dihydroxytartaric acid, alanine, taurine, aminoethylaminopropylsulfonate, glycerol phosphate disodium dehydrate, or combinations thereof. In one example, the acid monomer can be dimethylolpropionic acid. In some examples, the acid monomer can be present in the copolymerization reaction at from 7.5 wt % to 25 wt %, from 10 wt % to 20 wt %, or from 12 wt % to 15 wt %.

Regarding the polyol, as the name indicates, this compound can have two or more hydroxyl groups. In some examples, the polyol can include polyester polyols; polyether polyols; polycarbonate polyols; poly(ethyleneoxide) polyols; polyhydroxy polyester amides; hydroxyl-containing polycaprolactones; hydroxyl-containing acrylic polymers; hydroxyl-containing epoxides; polyhydroxy polycarbonates; polyhydroxy polyacetals; polyhydroxy polythioethers; polysiloxane polyols; ethoxylated polysiloxane polyols; polybutadiene polyols; hydrogenated polybutadiene polyols; polyisobutylene polyols; polyacrylate polyols; halogenated polyesters; halogenated polyethers; Bisphenol A; Bisphenol A ethoxylate (BPAE); Bisphenol A (2,3-dihydroxypropyl) glycidyl ether; Bisphenol A bis(3-chloro-2-hydroxypropyl) ether; Bisphenol A bis(2,3-dihydroxypropyl) ether; Bisphenol A glycerolate (1 glycerol/phenol) diacrylate; Bisphenol A propoxylate; 4,4′-(1-phenylethylidene)bisphenol; 4,4′-sulfonyldiphenol; 4,4′-dihydroxybiphenyl; 2,2′-biphenol; 4,4′-thiodiphenol; Bis[4-(2-hydroxyethoxy)phenyl] sulfone; 4,4′-sulfonylbis(2-methylphenol); or combinations thereof. In one example the polyol can be a polycarbonate polyol. In some examples, the polyol can be present in the copolymerization reaction at from 5 wt % to 55 wt %, from 20 wt % to 50 wt %, or from 35 wt % to 45 wt %. In other examples, the polyol can have a weight average molecular weight from 500 Mw to 5,000 Mw, from 100 Mw to 1000 Mw, or from about 750 Mw to about 3,000 Mw.

In further detail regarding the copolymerization of the hydrophilic polyurethane, the copolymerization reaction can further include a polyethyleneoxide compound. The polyethyleneoxide compound can include polyetheramines, methoxy polyethylene glycol, polyethyleneoxide diol, or combinations thereof. Commercially available examples can include YMER™ N-120 (Perstop Holding AB, Sweden), Jeffamine® M-700, Jeffamine® M-2070 (both available from Huntsman Corp., Massachusetts), and methoxy polyethylene glycol (Millipore Sigma, Missouri). In some examples, the polyethyleneoxide compound can be present at from 0 wt % to 5 wt %, from 0.9 wt % to 1.2 wt %, or from 0.1 wt % to 1 wt %. In one example, the polyethylene compound can have a water solubility of greater than 10 wt % and a hydroxyl functionality ranging from 1.8 to 3.

The aqueous pigment dispersion and the latex ink composition can further include organic co-solvent. With respect to the aqueous pigment dispersion, the organic co-solvent can be present at from 2 wt % to 30 wt %, from 5 wt % to 25 wt %, from 15 wt % to 30 wt %, or from 5 wt % to 10 wt %. When formulating latex ink composition, more organic co-solvent or less organic co-solvent may be used, e.g., by diluting the organic co-solvent content or by adding more organic co-solvent when formulating the latex ink composition. In one example, in the latex ink composition, the organic co-solvent can be present at from 5 wt % to 40 wt %, from 10 wt % to 35 wt %, from 15 wt % to 30 wt %, from 20 wt % to 30 wt %, or from 10 wt % to 30 wt %. Water can also be included in the aqueous pigment dispersion and in the latex ink composition. The amount of water in the aqueous pigment dispersion from 40 wt % to 90 wt %, from 50 wt % to 85 wt %, or from 60 wt % to 90 wt %. Again, when formulating latex ink composition, more or less water may be present compared to the aqueous pigment dispersion, e.g., by diluting the water content or by adding more water when formulating the latex ink composition. For example, the water content in the latex ink composition can be from 20 wt % to 98 wt %, from 30 wt % to 80 wt %, from 40 wt % to 90 wt %, or from 50 wt % to 75 wt %.

The aqueous pigment dispersion can be used to formulate the latex ink composition of the present disclosure. In addition to the water, organic co-solvent, quinacrodone pigment, dispersants, other ingredients that may be present in the aqueous pigment dispersion, more of these components or these types of components can be admixed with the aqueous pigment dispersion, along with a latex (which includes by definition additional water and latex particulates, and potentially other ingredients), to form a latex ink composition suitable for jetting from inkjet architecture. In one example, the aqueous pigment dispersion can be formulated in the latex ink composition so that the pigment content, including the dispersant content, can be present at from 1 wt % to 7 wt %, from 2 wt % to 6 wt %, from 1 wt % to 5 wt %, from 2 wt % to 5 wt %, or from 2 wt % to 4 wt %.

Furthermore, the latex ink compositions of the present disclosure can further include latex particles. The latex particles can be present at from 1 wt % to 15 wt %, from 3 wt % to 12 wt %, or from 5 wt % to 10 wt %. The latex particles can be polymerized copolymers, such as emulsion polymers, of one or more monomer, and can also be prepared using a reactive surfactant in some examples. Exemplary reactive surfactants can include polyoxyethylene alkylphenyl ether ammonium sulfate surfactant, alkylphenol ethoxylate free polymerizable anonioc surfactant, sodium polyoxyethylene alkylether sulfuric ester based polymerizable surfactant, or a combination thereof. Commercially available examples include Hitenol® AR series, Hitenol® KH series (e.g. KH-05 or KH-10), or Hitenol® BC series, e.g., Hitenol® BC-10, BC-30, (all available from Montello, Inc., Oklahoma), or combinations thereof. Exemplary monomers that can be used include styrene, alkyl methacrylate (for example C1 to C8 alkyl methacrylate), alkyl methacrylamide (for example C1 to C8 alkyl methacrylamide), butyl acrylate, methacrylic acid, or combinations thereof. In some examples, the latex particles can be prepared by combining the monomers as an aqueous emulsion with an initiator. The initiator may be selected from a persulfate, such as a metal persulfate or an ammonium persulfate. In some examples, the initiator may be selected from a sodium persulfate, ammonium persulfate or potassium persulfate. Latex particles can have a particle size ranging from 20 nm to 500 nm, from 50 nm to 350 nm, or from 150 nm to 270 nm.

Thus, in accordance with examples of the present disclosure, a latex ink composition can be prepared to include the ingredients in Table 1 below. These ranges are exemplary only, and thus, can be modified.

TABLE 1
Latex Ink Compositions

| Ingredient | Weight Percent (wt %) |
|---|---|
| ¹Quinacridone pigment | 1-7 |
| Organic co-solvent | 5-40 |
| Latex particles | 1-15 |
| Water | Balance |

¹co-dispersed with styrene-acrylic dispersant and a hydrophilic polyurethane dispersant

In addition to the ingredients shown in Table 1, the latex ink compositions can further include other liquid or solid components. For example, in some examples, the ink composition can include wax particles. The wax particles can be from a naturally occurring wax, a synthetic wax, or a combination thereof. Exemplary waxes can include beeswax, lanolin, carnauba, jojoba, paraffin, microcrystalline, micronized, polyethylene, polypropylene, polyamide, poly tetrafluoroethylene, or combinations thereof. In one example, the wax can be polyethylene emulsion. A commercially available example can include Aquaslip™ and Liquilube™ 405 (both available from The Lubrizol Corp., Ohio). In some examples, the wax particles can be filtered. When incorporated, the wax particles can be included in the latex ink composition from about 0.1 wt % to about 3 wt %, from about 0.1 wt % to 2 wt %, or from about 0.5 wt % to 1 wt %.

With specific reference to the aqueous pigment dispersion, the organic co-solvent can include 2-methyl-1,3-propanediol (MPDiol); 2-pyrrolidone (2P), 1,2-propanediol, 1,2-butanediol, ethylene glycol, 2-methyl-2,4-pentanediol, 1,3-butanediol, 1,3-propanediol, ethylene glycol 2-ethylhexyl ether, dipropylene glycol n-butyl ether, diethylene glycol n-butyl ether, propylene glycol phenyl ether, tripropylene glycol methyl ether, 2,2,4-trimethyl-1,3-pentanediol monoisobutyrate, triethyl citrate, tripropylene glycol n-propyl ether, tripropylene glycol n-butyl ether, tetraethylene glycol dimethyl ether, dipropylene glycol phenyl ether, or combinations thereof. Other organic co-solvents can of course be used in some instances, and furthermore, when formulating the latex ink composition from the aqueous pigment dispersion, a lengthy list of organic co-solvents along with many other types of ingredients, can also be included. For example, the aqueous liquid vehicle can include organic co-solvents compatible with the various components in the latex ink composition, including polar solvents such as alcohols, amides, esters, ketones, lactones, and ethers. In some examples the co-solvent can be an aliphatic alcohol, an aromatic alcohol, diol, glycol ether, polyglycol ether, caprolactam, formamide, acetamide, long chain alcohol, or combinations thereof. Exemplary co-solvents can include 2-methyl-1,3-propanediol (MPDiol); 2-pyrrolidone (2P); 2-ethyl-2-(hydroxymethyl)-1,3-propane diol; glycerol; N-methylpyrrolidone; dimethyl sulfoxide; sulfolane; glycol ethers; alkyldiols; 1,2-hexanediol; ethoxylated glycerols; LEG-1 (Liponic® EG-1); or combinations thereof. In one example, the co-solvent in the aqueous liquid vehicle can include 2-methyl-1,3-propanediol; 2-pyrrolidone; or combinations thereof. The co-solvents can be present in the aqueous liquid vehicle, as mentioned, at from 5 wt % to 40 wt %, from 10 wt % to 35 wt %, from 15 wt % to 30 wt %, from 20 wt % to 30 wt %, or from 10 wt % to 30 wt %.

In some examples, the aqueous liquid vehicle can include surfactant. In one example, the surfactant can include one or more non-ionic surfactants, fluorosurfactants, phosphate ester surfactants, alkyl polyethylene oxides, alkyl phenyl polyethylene oxides, polyethylene oxide block copolymers, acetylenic polyethylene oxide, polyethylene oxide amines, polyethylene oxide esters, dimethicone copolyols, ethoxylated surfactants, alcohol ethoxylated surfactants, or combinations thereof. Exemplary surfactants can include oleth-3 phosphate (commercially available as Crodafos™ N3 acid from Croda® International Plc, England); secondary alcohol ethoxylates (commercially available as Tergitol®-S-7 and Tergitol® TM-6 from Union Carbide Corp., New York); fluorinated polymeric surfactant (commercially available as Capstone™ FS-35 available from DuPont™ Chemicals and Fluoroproducts, Delaware); or combinations thereof. If present, the surfactant can be included in the aqueous liquid vehicle from 0.1 wt % to 5 wt %, from 1 wt % to 3 wt %, or from 0.5 wt % to 2.5 wt %.

In yet other examples the aqueous liquid vehicle can include various other additives. Examples of these additives can include additives to inhibit the growth of harmful microorganisms, sequestering agents, viscosity modifiers, and the like. Exemplary additives that can be used to inhibit the growth of harmful microorganisms can include biocides, fungicides, microbial agents, and the like. Commercially available microbial agents can include Acticide (Thor Specialties, Inc., Connecticut), Nuosept™ (Ashland™ Global Holdings Inc., North America), Ucarcide™ (Union carbide Corp., New Jersey), Vancide® (R.T. Vanderbilt Holding Co., Connecticut), Proxel™ (Imperial Chemical Industries, Inc., New Jersey), or combinations thereof. Sequestering agents, such as EDTA (ethylene diamine tetra acetic acid), can be included to eliminate the deleterious effects of multi-valent metal impurities and buffer solutions can be used to control the pH of the ink. Viscosity modifiers and buffers can also be present, as well as other additives known to those skilled in the art to modify properties of the latex ink compositions as desired. Individuals skilled in the art are aware of these additives and other additives that can used in latex ink compositions.

The latex ink compositions presented herein can exhibit good stability when stored as a bulk dispersion. These latex ink compositions do not exhibit significant changes in viscosity following exposure to even multiple freeze-thaw cycles (a single freeze-thaw cycle includes freezing the latex ink composition to −40° C. and then heating to 70° C.), and furthermore, they do not tend to exhibit significant changes in viscosity following accelerated shelf-life testing. In addition, the latex ink compositions described herein can exhibit good decap performance and no decel. Decap performance was measured based on the number of spits needed to generate a good printed line at 7 seconds of uncapped time. Lower numbers of spits indicate better decap performance. Decel refers to the decrease of drop velocity over time during continuous firing of the pen. No decel is preferred when the decrease of drop velocity is 0. Acceptable decel performance for these inks can be characterized by the decrease of drop velocity less than 1 m/s. Without being limited by theory, it is believed that these features can be attributed to the co-dispersion of the quinacridone pigments by the styrene-acrylic dispersant and the hydrophilic polyurethane dispersant.

In further detail, the present disclosure is also drawn to a method for formulating a latex ink composition, as shown in FIG. 2. The method 100 can include admixing 102 an aqueous latex dispersion and an aqueous pigment dispersion in a liquid vehicle to form the latex ink composition. The aqueous pigment dispersion can be a quinacridone pigment co-dispersed by a styrene-acrylic dispersant and a hydrophilic polyurethane dispersant. The latex ink composition can include from 1 wt % to 7 wt % of the quinacridone pigment and from 1 wt % to 15 wt % latex particles. The individual components of the latex ink composition can be as described herein.

It is noted that, as used in this specification and the appended claims, the singular forms “a,” “an,” and “the” include plural referents unless the content clearly dictates otherwise.

As used herein, the term “about” is used to provide flexibility to a numerical range endpoint by providing that a given value may be “a little above” or “a little below” the endpoint. The degree of flexibility of this term can be dictated by the particular variable and would be within the knowledge of those skilled in the art to determine based on experience and the associated description herein.

As used herein, “decap” performance refers to the ability of a latex ink to readily eject from a print head upon prolonged exposure to air. When a print head is exposed to air for a period of time, its nozzles can no longer fires properly, potentially because of clogging or plugging. Spiting to clear the clogs or plugs are necessary to achieve good print quality. Decap performance is measured by number of spits required to achieve good print quality when the print head is exposed to air for a given time. The smaller number of spits required for an ink means it has better decap performance at a given time.

“Decel” is short for declaration and refers to a decrease of drop velocity in the unit meters per second (m/s) over time during continuous firing of a print head.

“Volume-weighted mean diameter” is the mean diameter of a co-dispersed quinacridone pigment particles within a specific volume.

The term “acid value or “acid number” refers to the minimum mass of potassium hydroxide (KOH) in milligrams that can be used to neutralize one gram of substance, such as the various dispersants disclosed herein.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, dimensions, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a weight ratio range of about 1 wt % to about 20 wt % should be interpreted to include not only the explicitly recited limits of about 1 wt % and about 20 wt %, but also to include individual weights such as 2 wt %, 11 wt %, 14 wt %, and sub-ranges such as 10 wt % to 20 wt %, 5 wt % to 15 wt %, etc.

### EXAMPLES

The following examples illustrate the technology of the present disclosure. However, it is to be understood that the following is only exemplary or illustrative of the application of the principles of the presented formulations and methods. Numerous modifications and alternative methods may be devised by those skilled in the art without departing from the spirit and scope of the present disclosure. The appended claims are intended to cover such modifications and arrangements. Thus, while the technology has been described above with particularity, the following provide further detail in connection with what are presently deemed to be the acceptable examples.

### Example 1

### Preparation of Hydrophilic Polyurethane Dispersant

A polyurethane dispersant was prepared from isophorone diisocyanate (IPDI), polycarbonate polyol Mw 1000 (Kuraray® C-1090), and 2,2′-dimethylol propionic acid (DMPA) using the relative weight percentages shown below in Table 2, as follows:

TABLE 2
Hydrophilic Polyurethane Dispersant

| Ingredient | Wt % |
|---|---|
| Isophorone diisocyanate (IPDI) | 43.6 |
| Polycarbonate polyol Mw 1000 (Kuraray ® C-1090)* | 43.2 |
| 2,2′-dimethylol propionic acid (DMPA) | 17.3 |

*Kuraray ® C-1090 is available from Kuraray Co. Ltd. (Japan).

Essentially, the ingredients were admixed with 86 mL of acetone in a 500 ml 4-neck round bottom flask, and a mechanical stirrer having a glass rod and Teflon® (E.I. du Pont de Nemours and Company, Delaware) blades were placed in the flask and a condenser was attached. The flask and condenser were kept under a dry nitrogen blanket and the flask was immersed in a bath at 70° C. and 6 drops of dibutyl dilaurate (DBTDL) were added to initiate the polymerization. Polymerization was continued for 4 hours at 70° C. 16.3 g of methanol was then added while stirring for 30 additional minutes. The polymer solution was then cooled to room temperature and slowly poured into an aqueous solution of 32.2 g of potassium hydroxide (45% solid) and 600 g of deionized water. Stirring continued for one hour and a translucent solution was obtained. The acetone was then removed from the flask with a rotary evaporator. The solution was filtered through a fiberglass filter paper. The resultant hydrophilic polymer had an acid number of 55.1, a number average molecular weight of 4.7 kg/mol, a weight average molecular weight of 22 kg/mol, a polydispersity index value of 4.7 (Mw/Mn), a percent non-volatile solids of 20, and an average particle size of 25 nm.

### Example 2

### Aqueous Pigment Dispersions

Several different pigment dispersions were formulated for incorporation in various latex ink composition. The aqueous pigment dispersions included a quinacridone pigment, namely 15 wt % Pigment Red 122, 5 wt % or 7.5 wt % 2-methyl-1,3-propanediol (MPDiol), and one or two pigment dispersants as identified in Table 3 below

TABLE 3
Formulation ID and Pigment Dispersion*

| | | | PU | |
|---|---|---|---|---|
| | Joncryl ® 671 | E-Sperse ® 100 | Dispersant | |
| Dispersion | Dispersant | Dispersant | (Example 1) | MPDiol |
| ID | (wt %) | (wt %) | (wt %) | (wt %) |
| 1 (Control 1) | 1.5 | 3.5 | — | 5 |
| 2 (Control 2) | 2.7 | — | — | 7.5 |
| A | 1.8 | — | 0.9 | 7.5 |
| B | 1.35 | — | 1.35 | 7.5 |
| C | 0.9 | — | 1.8 | 7.5 |

All pigment dispersions included Pigment Red 122 at 15 wt % and water to balance.
Joncryl ® 671is a styrene-acrylic polymer from BASF Corp. (Germany).
E-sperse ® 100 an anionic dispersant from Ethox Chemicals, LLC (S. Carolina).
PU Dispersant is a hydrophilic polyurethane dispersant (See Example 1).

### Example 3

### Latex Ink Compositions

The pigment dispersions of Example 2 (Table 3) were then admixed with other ingredients to form latex ink compositions to test ink stability, decap performance, and decel performance. The ingredients in the latex ink compositions are shown in Table 4 below.

TABLE 4
Latex Ink Composition

| Ingredient | Type | Wt % |
|---|---|---|
| 2-pyrrolidinone (2P) | Organic Co-solvent | 13 |
| 2-methyl-1,3-propanediol (MPDiol) | Organic Co-solvent | 9 |
| Oleth-3 phosphate | Anionic Surfactant | 0.2 |
| (Crodafos ™ N-3 Acid) | | |
| Tergitol ® 15-S-7 | Non-ionic surfactant | 0.5 |
| Tergitol ® TMN-6 | Non-ionic surfactant | 0.9 |
| Capstone ™ FS-35 | Non-ionic fluoro- | 0.65 |
| | surfactant | |
| Trisodium salt of | Chelating agent | 0.04 |
| methylglycinediacetic acid | | |
| (Na₃MGDA) (Trilon ® M) | | |
| 20 wt % 1,2-Benzisothiazolin-3-one | Microbiocide | 0.2 |
| (Acticide ® B20) | | |
| Polyethylene emulsion | Wax | 0.8 |
| (Liquilube ™ 405 wax) | | |
| Copolymer of styrene, methyl | Latex Particles | 7 |
| methacrylate, butyl acrylate and | | |
| methacrylic acid | | |
| Aqueous pigment dispersion | Pigment | 3 (Pigment |
| (see Table 3) | | Content) |
| Deionized water | Solvent | balance |

Crodafos ™ is available from Croda ® International Plc, (England).
Tergitol ® is available from Union Carbide Corp. (New York).
Capstone ™ is available from DuPont ™ Chemicals and Fluoroproducts, (Delaware).
Trilon ® is available from BASF Corp. (Germany).
Acticide ® is available from Thor Specialties, Inc. (Connecticut).
Liquilube ™ is available from The Lubrizol Corp. (Ohio).

### Example 4

### Viscosity, Freeze-Thaw Viscosity, Accelerated Shelf Life (ASL), Particle Size Distribution, and D95 Particle Size

The initial viscosity, viscosities after freeze-thaw and accelerated shelf-life (ASL) testing were measured on a Viscolite viscometer. Samples were equilibrated to 25±1° C. in a water batch before the measurements.

The samples were also tested with respect to particle size including volume averaged particle size (Mv) and particle size at which 95% of the particles are smaller and only 5% are larger (D95), both before and after freeze-thaw cycling and accelerated shelf-life testing, using a NanoTrac® 150 particle size system.

To test freeze-thaw viscosity related changes, 5 freeze-thaw cycles were performed on each of the samples (30 mL samples were tested). During an individual freeze-thaw cycle, a sample was placed in an oven with the temperature ramped from initial temperature to 70° C. in 20 min, and maintained at 70° C. for 4 hr, decreased from 70° C. to −40° C. in 20 min and maintained at −40° C. for 4 hr. This process was repeated, such that each sample was subjected to a total of 5 freeze-thaw cycles. Following the fifth cycle, each of the samples was allowed to equilibrate to room temperature, and the viscosity and particle size were tested.

In order to determine the accelerated shelf-life (ASL), a 30 mL sample of each of the formulations were stored in an oven set to 60° C. for 7 days. Following the storage period, each of the samples were allowed to equilibrate to room temperature, and the viscosity and particle size were tested.

The results of the testing for the initial viscosity, freeze-thaw viscosity related changes, accelerated shelf life, particle size including Mv and D95 are shown in Tables 5A-5C. Notably, Ink 1 was prepared from Dispersion 1 (Control 1), Ink 2 was prepared from Dispersion 2 (Control 2), Ink A was prepared from Dispersion A, Ink B was prepared from Dispersion B, and Ink C was prepared from Dispersion C. For further comparison, Ink 0, made from a quinacridone pigment that was dispersed by a styrene acrylic polymer (acid number 172/Mw 10,000) and a proprietary magenta synergist, was also compared. In Tables 5A-5C below, V=Viscosity; T-cycle=5 Freeze-Thaw Cycles from −40° C. to 70° C.; ASL=Accelerated Shelf Life (ASL) at 60° C. for 1 week; Mv=Volume Averaged Particle Size; and D95=95 Percentile Particle Size.

TABLE 5A
Viscosity (V - cP)

| Ink ID | Initial | T-cycle | % Δ T-cycle | ASL | % Δ ASL |
|---|---|---|---|---|---|
| Ink 0 | 3.3 | 3.3 | 0.0 | 3.3 | 0.0 |
| Ink 1 | 4.2 | 4.5 | 7.1 | 4.6 | 9.5 |
| Ink 2 | 3.1 | 3.6 | 16.1 | 5.4 | 74.2 |
| Ink A | 3.1 | 3.1 | 0.0 | 3.1 | 0.0 |
| Ink B | 3.1 | 3.0 | −3.2 | 3.0 | −3.2 |
| Ink C | 3.1 | 3.1 | 0.0 | 3.1 | 0.0 |

TABLE 5B
Particle Size (Mv - μm)

| Ink ID | Initial | T-cycle | % Δ T-cycle | ASL | % Δ ASL |
|---|---|---|---|---|---|
| Ink 0 | 0.187 | 0.186 | −0.4 | 0.201 | 7.3 |
| Ink 1 | 0.214 | 0.236 | 10.3 | 0.221 | 3.2 |
| Ink 2 | 0.215 | 0.238 | 11.0 | 0.278 | 29.4 |
| Ink A | 0.216 | 0.221 | 2.6 | 0.215 | −0.5 |
| Ink B | 0.218 | 0.216 | −1.2 | 0.222 | 1.6 |
| Ink C | 0.218 | 0.218 | 0.0 | 0.216 | −0.9 |

TABLE 5C
D95 Particle Size (D95 - μm)

| | Initial | T-cycle | % Δ T-cycle | ASL | % Δ ASL |
|---|---|---|---|---|---|
| Ink 0 | 0.323 | 0.316 | −2.2 | 0.335 | 3.7 |
| Ink 1 | 0.299 | 0.347 | 15.9 | 0.342 | 14.3 |
| Ink 2 | 0.335 | 0.379 | 13.1 | 0.426 | 27.2 |
| Ink A | 0.331 | 0.339 | 2.4 | 0.342 | 3.3 |
| Ink B | 0.335 | 0.328 | −2.1 | 0.328 | −2.1 |
| Ink C | 0.335 | 0.354 | 5.7 | 0.364 | 8.7 |

As can be seen in Tables 5A-5C above, the freeze-thaw and accelerated shelf life related viscosity changes were generally good for all of the samples with the exception of Ink 2 which exhibited about a 16% increase in viscosity after five freeze-thaw cycles and 74.2% increase in viscosity after accelerated shelf life testing. The particle size stability was good for all samples with the exception of Ink 1 and Ink 2. An increase in My for Ink 1 and Ink 2 indicated that flocculation occurred. The D95 also yielded similar results. The particle size of the pigments of Inks 1 and 2 both increased greater than 10% following freeze-thaw cycling. The particle size of the pigments of Ink 2 also increased by 27% following accelerated shelf life testing. It seems that the pigments contained within the control inks agglomerated because the dispersant may have only reacted with a portion of the pigment, thereby leaving portions of the pigment exposed and allowing for pigment agglomeration. Ink 0, and Inks A, B, C exhibited good stability.

### Example 5

### Decap Performance and Decel Performance

The ink compositions prepared in accordance with Table 4 using the various aqueous pigment dispersions of Table 3 were also tested for decap performance and decel performance. Ink 0 described in Example 4 was also included in the testing. In order to test decap performance, plots were printed using a surrogate color printing tool. A one inch square block was printed with each ink formulation to ensure proper nozzle firing, then a pattern was printed with the nozzles, a rest period of 7 second occurred, and the pattern was then re-printed. The amount of spitting to achieve a good line on the decap pattern plot with the rest period of 7 seconds was recorded, and the results are shown in Table 6 below.

Likewise, in order to determine decel performance, each of the formulations were filled into a thermal inkjet print head and were continuously fired at 28 V. The initial drop velocity was 9-10 meters per second (m/s) and the deceleration was measured over 6 seconds. The loss in velocity is also shown in Table 6 below.

TABLE 6
Decap Performance and Decel Performance

| | Decap 7 s | |
|---|---|---|
| | (number of spits | Decel |
| Ink ID | for acceptable line) | (m/s) |
| Ink 0 | 4 | 3.5 |
| Ink 1 | 6 | 2.5 |
| Ink 2 | 5 | 0 |
| Ink A | 4 | 0 |
| Ink B | 4 | 0 |
| Ink C | 3 | 0 |

As can be seen in Table 6, the decap performance for Ink 1 and Ink 2 (control inks) was worse than the rest and the deceleration performance was also poor for Ink 1 and for the Ink 0. Thus, as evident from Tables 5A-5C, and Table 6, the only latex ink compositions that exhibited desirable performance in all three areas (stability, decap performance, and decel performance) were Inks A, B, and C. Thus, the latex ink compositions containing quinacridone dispersions with a styrene-acrylic resin and a hydrophilic polyurethane dispersant outperformed the control inks.

While the present technology has been described with reference to certain examples, those skilled in the art will appreciate that various modifications, changes, omissions, and substitutions can be made without departing from the spirit of the disclosure. It is intended, therefore, that the disclosure be limited only by the scope of the following claims.

What is claimed is:

1. An aqueous pigment dispersion, comprising:
from 40 wt % to 90 wt % water;
from 2 wt % to 30 wt % organic co-solvent;
from 7.5 wt % to 30 wt % quinacridone pigment;
from 0.5 wt % to 3.5 wt % styrene-acrylic dispersant; and
from 0.5 wt % to 3.5 wt % hydrophilic polyurethane dispersant having an acid number from 20 to 100,
wherein the styrene-acrylic dispersant and the hydrophilic polyurethane dispersant are present at a weight ratio from 1:5 to 5:1.

2. The aqueous pigment dispersion of claim 1, wherein the quinacridone pigment and total dispersant content are present at a weight ratio from 15:1 to 2:1.

3. The aqueous pigment dispersion of claim 1, wherein the styrene-acrylic dispersant has a weight average molecular weight from 4,000 Mw to 30,000 Mw and an acid number ranging from 100 to 350, and wherein the hydrophilic polyurethane has a weight average molecular weight from 3,000 Mw to 20,000 Mw.

4. A latex ink composition, comprising:
an aqueous liquid vehicle;
from 1 wt % to 7 wt % quinacridone pigment co-dispersed by a styrene-acrylic dispersant and a hydrophilic polyurethane dispersant; and
from 1 wt % to 15 wt % latex particles.

5. The latex ink composition of claim 4, wherein the quinacridone pigment comprises a co-crystal of two quinacridone pigments.

6. The latex ink composition of claim 4, wherein the quinacridone pigment and total dispersant content are present at a weight ratio from 15:1 to 2:1.

7. The latex ink composition of claim 4, wherein the styrene-acrylic dispersant and the hydrophilic polyurethane dispersant are present at a weight ratio from 1:5 to 5:1.

8. The latex ink composition of claim 4, wherein the styrene-acrylic dispersant has a weight average molecular weight ranging from 4,000 Mw to 30,000 Mw and an acid number ranging from 100 to 350, and wherein the hydrophilic polyurethane has a weight average molecular weight from 3,000 Mw to 20,000 Mw and an acid number from 20 to 100.

9. The latex ink composition of claim 4, wherein the hydrophilic polyurethane dispersant has an average particle size ranging from 0.1 nm to 30 nm.

10. The latex ink composition of claim 4, wherein the hydrophilic polyurethane is a copolymerization product of from 25 wt % to 70 wt % of a non-aromatic polyisocyanate, from 5 wt % to 25 wt % of an acid monomer including one or both of a hydroxyl functional group or an amino functional group, and from 1 wt % to 60 wt % of a polyol.

11. The latex ink composition of claim 10, wherein the acid monomer is dimethylolpropionic acid.

12. The latex ink composition of claim 10, wherein the non-aromatic polyisocyanate is isophorone diisocyanate.

13. The latex ink composition of claim 4, wherein the latex particles comprise a polymerized copolymer of a reactive surfactant and a monomer, wherein the reactive surfactant is a polyoxyethylene alkylphenyl ether ammonium sulfate surfactant, an alkylphenol ethoxylate free polymerizable anionic surfactant, a sodium polyoxyethylene alkylether sulfuric ester based polymerizable surfactant, or a combination thereof; and wherein the monomer is styrene, alkyl methacrylate, alkyl methacrylamide, butyl acrylate, methyacrylic acid, or a combination thereof.

14. A method of formulating a latex ink composition, comprising admixing an aqueous latex dispersion and an aqueous pigment dispersion including a quinacridone pigment dispersed by a styrene-acrylic dispersant and a hydrophilic polyurethane dispersant in a liquid vehicle to form the latex ink composition, wherein the latex ink composition includes from 1 wt % to 7 wt % of the quinacridone pigment and from 1 wt % to 15 wt % latex particles.

15. The method of claim of claim 14, wherein the styrene-acrylic dispersant has a weight average molecular weight from 4,000 Mw to 30,000 Mw and an acid number from 100 to 350, and wherein the hydrophilic polyurethane has a weight average molecular weight from 3,000 Mw to 20,000 Mw and an acid number from 20 to 100.
